(19) United States
(12) Patent Application Publication
(10) Pub. No.: US 2004/0052712 A1
(43) Pub. Date: Mar. 18, 2004

(54) Method for operating a flue gas purification plant

(76) Inventor: Gisbert Wolfgang Kafer, Birmenstof (CH)

Correspondence Address: ADAM J. CERMAK, P.O. BOX 7518, ALEXANDRIA, VA, 22307-7518, US

(21) Appl. No.: 10/660,523

(22) Filed: Sep. 12, 2003

(30) Foreign Application Priority Data
Sep. 14, 2002 (DE) 102 42 774.7

(51) Int. Cl. B01D 53/60

(52) U.S. Cl. 423/247

(57) ABSTRACT

In a method for operating a flue gas purification plant (10) with at least one absorber chamber (11), in which CO and NO are simultaneously oxidized by means of a catalyst in a first absorber (15) according to the SCONOx principle and the resulting NO₂ is absorbed on the catalyst surface, and in which SO₂ is furthermore oxidized by means of a catalyst in a second absorber (14) upstream of the first absorber (15) according to the SCOSOx principle and the resulting SO₃ is absorbed on the catalyst surface, the absorber chamber (11) is disconnected from the flue gas stream in regularly repeating regeneration cycles and regenerated by means of a regeneration gas containing hydrogen and/or hydrogen compounds, the two absorbers (14, 15) of the absorber chamber (11) being regenerated in succession and regeneration gas being injected into the absorber chamber (11) between the two absorbers (14, 15).

In this method, in order to prevent the regeneration from being impaired by the flue gas present in the absorber chamber (11), the section of the absorber chamber (11) with the absorber to be regenerated later is first purged with a purge gas before the start of the regeneration of the absorber which is regenerated first.

### BACKGROUND OF THE INVENTION

1. Field of the Invention

The present invention concerns the field of flue gas purification technology. It relates to a method for operating a flue gas purification plant according to the preamble of claim 1.

2. Discussion of Background

The brand name SCONOx describes a relatively new process for reducing NOx emissions in combustion flue gases of gas turbines, diesel engines and the like. NOx is deposited as potassium nitrite and potassium nitrate on an SCONOx absorber (see U.S. Pat. No. 5,953,911 and the article by L. Czarnecki et al., SCONOx—Ammonia Free NOx Removal Technology for Gas Turbines, Proc. of 2000 Int. Joint Power Generation Conf., Miami Beach, Fla., Jul. 23-26, 2000).

Since it is easy for the SCONOx absorber to be deactivated by SO₂ in the flue gas, another absorber is connected upstream of it—a so-called SCOSOx absorber—which absorbs SO₂ from the flue gas and hence protects the SCONOx absorber. The chemical reactions taking place in the two absorbers are described in detail in the aforementioned article by L. Czarnecki.

As soon as the deposition capacity of at least one of the absorber types has been exhausted (typically after about 20 minutes), the absorbers need to be regenerated. This is done by subdividing the overall absorber into individual chambers, which can be individually disconnected from the flue gas stream by using switchable dampers. For regeneration, selected chambers are disconnected from the flue gas stream while the other chambers remain in the flue gas stream. A regeneration gas, which consists of hydrogen, natural gas or other hydrocarbons and an oxygen-free carrier gas (usually steam), is passed through the disconnected chambers in order to regenerate both the NOx absorbers and the SO₂ absorbers of the chambers in question. However, since the two different absorber types respond differently during the regeneration, they are regenerated separately. This is made possible by an arrangement of feed and discharge lines and valves for the regeneration as reproduced by way of example in FIG. 1.

FIG. 1 shows an absorber chamber 11 of a flue gas purification plant 10, through which flue gas to be purified is sent from a combustion process. The unpurified flue gas 25 flows into the chamber 11 from the left. The purified flue gas 26 flows out of the chamber 11 again toward the right. The chamber 11 can be disconnected from the flue gas stream for regeneration purposes using two dampers 12 and 13, which are arranged at the input and the output. In the figure, the dampers 12, 13 have already been closed.

In the chamber 11, a first absorber 14 (SCOSOx) for absorbing SO₂ and a second absorber 15 (SCONOx) for absorbing NOx are arranged successively spaced apart in the flow direction. A feed line 26 for the regeneration gas opens via a first valve 17 (inlet valve) into the intermediate space between the first and second absorbers 14 and 15. Discharge lines 21 and 24, in which a second valve 16 and a third valve 19 (outlet valves) are respectively fitted, are connected before the first absorber 14 and after the second absorber 15, as seen in the flow direction. Within a regeneration phase, the first valve (inlet valve) 17 is opened so that regeneration gas can flow in. The other two valves (outlet valves) 16 and 19 are opened in succession, so that the associated absorbers 14 and 15 can be regenerated successively. The SO₂ absorber 14 is usually regenerated first (valves 16 open; valve 19 closed). The regeneration gas in the feed line 27 is produced from steam 23, by means of a reformer 20, and natural gas containing methane delivered through a valve 18.

In the flue gas purification plant 10, typically about ten chambers 11 of the type represented in FIG. 1 are connected in parallel, two of which will be in the regeneration phase at any given time. With a regeneration time of 5 minutes per individual regeneration, 25 minutes are required in total to regenerate each of the chambers 11 once (=25-minute cycle time).

While the SCOSOx absorber 14 is being regenerated, flue gas containing oxygen is still present in the section of the absorber chamber 11 which contains the SCONOx absorber 15. A CFD (computational fluid dynamics) analysis of the flow distribution inside the absorber chamber 11 during the regeneration has now shown that there is a risk that some of this flue gas may be entrained in the injection zone owing to turbulence, so that oxygen could enter the SCOSOx absorber 14. However, the presence of oxygen can impede the regeneration of the SCOSOx absorber. This may lead to local breakthrough of SO₂ during the absorption phase, and therefore to accelerated deactivation of the SCONOx absorber.

### SUMMARY OF THE INVENTION

Accordingly, one object of the invention is to provide a novel method for operating, and in particular for regenerating, a combined SCOSOx/SCONOx flue gas purification plant which reduces or fully eliminates the risk of the regeneration of the SCOSOx absorber being compromised by flue gas containing oxygen.

The object is achieved by all the features of claim 1. The central feature of the invention is that the section of the absorber chamber with the absorber to be regenerated later is first purged with a purge gas before the start of the regeneration of the absorber which is regenerated first. In this way, remaining flue gas components which may compromise the regeneration of the absorber are substantially removed from the absorber chamber before the actual regeneration begins.

The regeneration gas is preferably used as the purge gas.

The method is particularly effective if the SCOSOx absorber is regenerated first and the SCONOx absorber is regenerated afterward.

The purging is preferably carried out over a time period of several seconds, in particular between 15 and 30 seconds.

Further refinements of the invention are given in the dependent claims.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows the exemplary layout of an individual chamber with SCONOx and SCOSOx absorbers and regeneration devices, in a flue gas purification plant such as is used in the prior art and is suitable for carrying out the method according to the invention; and

FIG. 2 shows a comparable representation to FIG. 1 of a modified flue gas purification plant which can also be operated with the method according to the invention.

### DESCRIPTION OF THE PREFERRED EMBODIMENTS

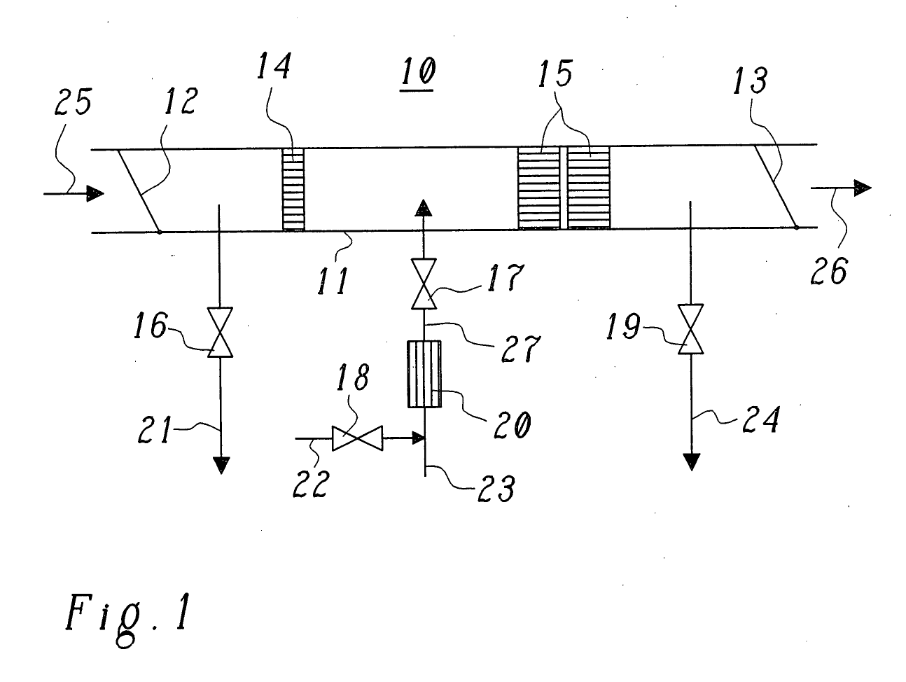

Referring now to the drawings, wherein like reference numerals designate identical or corresponding parts throughout the several views, it is proposed according to the invention that the section of the absorber chamber with the absorber to be regenerated second (generally the SCONOx absorber) be purged before the regeneration of the absorber which is regenerated first (generally the SCOSOx absorber) is begun. In the arrangement of the flue gas purification plant 10 in FIG. 1, this means that after the dampers 12, 13 have been closed, the outlet valve 19 is first opened for a predetermined time period in order (with the regeneration gas flowing in through the inlet valve 17) to purge the section with the SCONOx absorber 15. The regeneration gas contains hydrogen and/or hydrogen compounds, for example hydrocarbons such as natural gas or propane. Since higher hydrocarbons can be converted more easily than methane (the main component of natural gas), this may constitute an alternative to natural gas subject to local availability. It is also conceivable to use higher hydrocarbons directly for the regeneration, i.e. without prior reforming into hydrogen. For the regeneration of the SCOSOx absorber 14, the outlet valve 19 is then closed and the outlet valve 16 is opened, so that the regeneration gas can flow through the SCOSOx absorber 14. Lastly, the outlet valve 16 is closed and the outlet valve 19 is re-opened, in order to regenerate the SCONOx absorber 15. A time period of from 15 to 30 seconds for the purging of the SCONOx absorber 15 is generally sufficient to remove the major part of the flue gas in this section of the absorber chamber.

In reality, the effective purging does not begin until the dampers 12, 13 have been closed fully. Since the inlet valves 17 are already open at that time when the dampers 12, 13 start to close, and it takes about 15 seconds for the dampers to be closed fully, the total opening time of the valves for purging should be between 30 and 45 seconds. Since the regeneration already begins during the purging phase, the purging does not add to the overall duration of the regeneration phase but can be regarded as part of the regeneration of the second absorber (generally the SCONOx absorber).

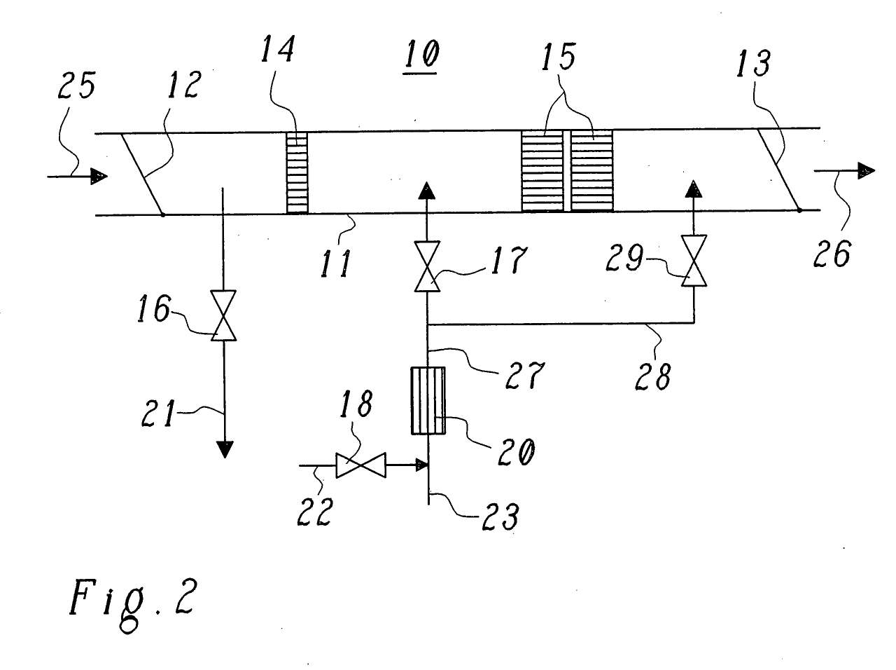

The purging according to the invention may also be employed with other valve configurations. An example of such a different configuration is reproduced in FIG. 2 and has two inlet valves 17 and 29 and one outlet valve 16. In this case, the inlet valve 29 (together with the outlet valve 16) is opened first in order to flush out the SCOSOx absorber 15, before the inlet valve 29 is then opened instead of the inlet valve 17 in order to regenerate the SCOSOx absorber 14. Lastly, the inlet valve 29 is re-opened in order to regenerate the SCONOx absorber 15.

Generally speaking, the invention can be used for all configurations and operating modes in which regeneration gas needs to be injected into the absorber chamber between an SCOSOx absorber and an SCONOx absorber while the chamber has not yet been filled completely with flue gas.

Obviously, numerous modifications and variations of the present invention are possible in light of the above teachings. It is therefore to be understood that within the scope of the appended claims, the invention may be practiced otherwise than as specifically described herein.

LIST OF DESIGNATIONS

| | |
|---|---|
| 10 | Flue gas purification plant |
| 11 | Absorber chamber |
| 12, 13 | Damper |
| 14 | Absorber (SCOSOx) |
| 15 | Absorber (SCONOx) |
| 16, . . . , 19 | Valve |
| 20 | Reformer |
| 21, 24 | Discharge line (regeneration) |
| 22 | Natural gas (NG) |
| 23 | Steam |
| 25 | Flue gas (unpurified) |
| 26 | Flue gas (purified) |
| 27, 28 | Feed line (regeneration) |
| 29 | Valve |

What is claimed as new and desired to be secured by Letters Patent of the United States is:

1. A method for operating a flue gas purification plant (10) with at least one absorber chamber (11), in which CO and NO are simultaneously oxidized by means of a catalyst in a first absorber (15) according to the SCONOx principle and the resulting NO₂ is absorbed on the catalyst surface, and in which SO₂ is furthermore oxidized by means of a catalyst in a second absorber (14) upstream of the first absorber (15) according to the SCOSOx principle and the resulting SO₃ is absorbed on the catalyst surface, in which method the absorber chamber (11) is disconnected from the flue gas stream in regularly repeating regeneration cycles and regenerated by means of a regeneration gas containing hydrogen and/or hydrogen compounds, the two absorbers (14, 15) of the absorber chamber (11) being regenerated in succession and regeneration gas being injected into the absorber chamber between the two absorbers (14, 15), characterized in that the section of the absorber chamber (11) with the absorber to be regenerated later is first purged with a purge gas before the start of the regeneration of the absorber which is regenerated first.

2. The method as claimed in claim 1, characterized in that the regeneration gas is used as the purge gas.

3. The method as claimed in one of claims 1 and 2, characterized in that the SCOSOx absorber (14) is regenerated first and the SCONOx absorber (15) is regenerated afterward.

4. The method as claimed in one of claims 1 to 3, characterized in that the purging is carried out over a time period of several seconds, in particular between 15 and 30 seconds.

5. The method as claimed in one of claims 1 to 4, characterized in that the absorber chamber (11) is disconnected from the flue gas stream by means of closable dampers (12, 13) at the input and output of the absorber chamber (11), in that the purging is controlled by inlet and outlet valves (16, 17, 19, 29), and in that the inlet and outlet valves (16, 17, 19, 29) have already been brought into the position necessary for the purging when the dampers (12, 13) are closed.
